(19) United States
(12) Patent Application Publication
(10) Pub. No.: US 2018/0117539 A1
(43) Pub. Date: May 3, 2018

(54) POLYIONIC AND MOLECULAR FILTER-DIFFUSER

(71) Applicants: Luis Pablo DÍAZ RIVERA GONZÁLEZ, Los Cabos (MX); Gustavo Adolfo SOLÍS CORTÉS, Ensenada (MX)

(72) Inventors: Luis Pablo DÍAZ RIVERA GONZÁLEZ, Los Cabos (MX); Gustavo Adolfo SOLÍS CORTÉS, Ensenada (MX)

(21) Appl. No.: 15/801,135

(22) Filed: Nov. 1, 2017

(30) Foreign Application Priority Data
Nov. 3, 2016 (MX) MX/U/2016/000514

(51) Int. Cl. B01F 3/04; C02F 1/74

(52) U.S. Cl. CPC B01F 3/04262; C02F 1/74; C02F 2103/007; B01F 2003/04333; B01F 2003/04361; B01F 2003/04319

(57) ABSTRACT

The present disclosure relates to a poly-ionic and molecular filtering and diffuser device, which provides for the emission of gases when used from the inside out, and a separation of suspended matter (e.g., in macro, micro and nano ranges) in liquids for a variety of fluids when is used from the outside inwards. The device may include a central diffuser tube defining a plurality of perforations in its wall to allow passage of gas and liquids, and which is inserted through central holes of a plurality of plates diffusers arranged in a vertical arrangement. This combination may define a plurality of slots by the separations generated therebetween, whereby the gas or the liquid is spread. The diffuser-separating plates are contained between a top compression cap and a lower compression cap through which said central diffuser-collector tube is also inserted. The central diffuser-collector tube includes a threaded lower end, wherein a final lower lid is threaded. Seal elements may be disposed between the upper and lower compression cap and the arrangement of the plurality of diffuser-separating plates.

### RELATED APPLICATIONS

This application claims priority to currently pending Mexican patent application MX/U/2016/000514 filed Nov. 3, 2016 entitled “DISPOSITIVO DIFUSOR MOLECULAR POLI-IONICO Y DE FILTRADO”, the contents of which are incorporated herein by reference in its entirety.

### BACKGROUND OF THE INVENTION

### 1. Technical Field

This disclosure generally relates to aerators for liquids and, more specifically, relates to a poly-ionic and filtering molecular diffuser device.

### 2. Related Art

Filters of various designs and configurations have been used in various fields to filter various fluids, including air, oil, water, among others. Any type of conventional filter, are configured in different sizes to obtain different results (and to be used with different viscosities), from nano and micro to macro filtration. By trapping more and more matter, these filters begin to cover and create pressure thus blocking the flow. Because of this blockage it is necessary for the filters to be replaced from time to time. Therefore it is of the utmost importance to avoid such blockages, and thus avoid unnecessary expenses on new filters.

U.S. Pat. No. 4,515,134 to Warren, II granted May 7, 1985, which discloses a molecular diffuser assembly adapted to replace the carburetor of an internal combustion engine, and is provided with a Venturi-type passage in communication with the internal combustion engine for the elaboration of passage of the same airstream. A heater/evaporator thermistor type assembly operates at a selected temperature to evaporate all volatile components of the liquid fuel introduced thereto and provides a substantially complete vapor fuel for delivery to the venturi for diffusion with the air stream passing through it. A control assembly controls the amount of vapor fuel discharged into the venturi in response to parametric information delivered thereto, said information indicative of the mass flow rate of the air stream flowing through the venturi. The vaporized fuel in the venturi throat represents the fuel molecules to an optimum degree of separation in order to react optimally with the oxidizing air stream. A mixture control valve is also provided for adjusting the fuel:air ratio in order to compensate for particular fuel enrichment requirements. As can be elucidated, this is directed a diffuser replacing an internal combustion engine carburetor, but does not disclose or suggest a molecular diffuser like that of the present disclosure.

U.S. Pat. No. 8,894,048 to Cai et al. granted Nov. 25, 2014 discloses a gas diffuser including a grid of separate aeration tubes in parallel alignment in a horizontal plane. The aeration tubes have improved the discharge orifice placement along its length and around its circumference to provide better performance and to reduce fouling of the membrane filtration systems associated therewith. This patent discloses only the distribution of aeration tubes and the distribution of the gas discharge ports, but does not disclose or suggest a molecular diffuser assembly with the structure, arrangement and operability as that of the present disclosure.

U.S. Pat. No. 8,985,558 to Kaczor granted Mar. 24, 2015 discloses a diffuser for the saturation of water with gas, the diffuser having a diffusion element for the diffusion of the gases that flow through the diffuser. There, the diffusion element is made of carbon. Kaczor also relates to an assembly for saturating the water with gas, as well as a method for the saturation of water with gas, and the use of carbon as a diffusion element. The diffuser is constructed entirely as a diffusion element made of carbon, has the shape of a cylinder or a rectangular parallelepiped, with a gas inlet tube attached thereto through a connector tube by means of a seal. The gas exits the diffuser through the pores of the diffusion element made of carbon. However, Kaczor does not disclose or suggest a molecular diffuser assembly with the structure, arrangement and operability as in the present disclosure.

### BRIEF SUMMARY OF THE INVENTION

Generally, the poly-ionic and filter molecular diffuser device disclosed herein may include a central diffuser-collector tube that defines a plurality of perforations in its wall to permit passage of gas/liquids, and which is inserted through central holes of a plurality of diffuser-separating plates arranged in a vertical arrangement, which define a plurality of slots in the separations generated therebetween, through which the gas is spread or the liquid to be filtered is penetrated, said plates diffuser-separators are contained between a top compression cap and a lower compression cap through which said central diffuser-collector tube is also inserted. The central diffuser-collector tube may include a threaded lower end wherein a final lower lid is threaded. Seal elements may be disposed between said upper and lower compression cap and the arrangement of the plurality of diffuser-separating plates.

In one of the preferred embodiments of the disclosure said central diffuser-collector tube includes fixedly next to its upper end, a base plate adapted to fix with a fixing means, a cylindrical housing that can be of any convenient form factor/shape (e.g., triangular, square, hexagonal, etc.), and likewise, of any size, thickness, and/or material, which internally protects the assembly of the central diffuser-collector tube (with the diffuser-separator plates and the upper and lower compression caps secured with the final lower lid). The housing may include a plurality of apertures in its perimeter and bottom walls, which permit the escape of gas bubbles (formed by the diffuser-separating plates when the gas is injected through the upper end of the diffuser-central collector) through the periphery of the housing, or which act as an inlet for liquid that is injected through the outer perimeter of the housing.

In other embodiments of the disclosure, a seal member is disposed between said end lower cap and said lower compression cap, or may be integral with said end lower cap.

In another embodiment of the disclosure, the end lower cap is integrated with said lower compression cap forming a unitary body.

In another embodiment of the disclosure, the central diffuser-collector tube may include a threaded upper end adapted to couple a filtered gas supply or collection pipeline.

In one of the preferred embodiments of the disclosure, the plurality of diffuser-separating plates may include at least one circumferential groove at the outer or inner edge, or a plurality of circumscribed circumferential grooves, made in one or both upper and lower faces to improve the distribution of the gas flow or the distribution of liquid collected when said device acts as a filter.

In another embodiment of the disclosure, the plurality of diffuser-separating plates may include a plurality of radial grooves on one or both upper and lower surfaces interconnected with the central orifice (through which said central diffuser-collector tube passes) to improve the radial distribution of the flow of gas or collected liquid. The grooves can be cut into a variety of shapes, depending on the gas being diffused and the type of application thereof. In another embodiment of the disclosure, the plurality of diffuser-separating plates may have different shapes and sizes.

The compression force imposed on the stacks of diffuser-separator plates may be controllable to define the size of the bubbles being emitted.

The device as described can be used as a gas air diffuser in liquids. Where the diffuser plates arranged in a vertical arrangement, it may serve well for converting air or incoming gas into bubbles of manageable size to aerate the liquid into which they are submerged, as is the case of tanks, treatment plants. etc.

The device as described may be suitable for filtering air as the water or liquid into which it is submerged traps any matter or smoke (such as those of the cigar), as could be done in factory exhaust fumes.

In order to better understand the features of the present disclosure, the accompanying drawings are attached as an integral part, but without being limiting in character.

### BRIEF DESCRIPTION OF THE DRAWINGS

FIG. 1 shows a longitudinal section of the poly-ionic diffuser, according to a preferred embodiment of the disclosure.

FIG. 2 is an exploded view of the poly-ionic diffuser, according to a preferred embodiment of the disclosure.

FIG. 3 is an exploded view of the poly-ionic diffuser, according to another preferred embodiment of the disclosure.

FIG. 4 shows a longitudinal section of the poly-ionic diffuser, according to another preferred embodiment of the disclosure.

FIG. 5 is a top plan view of a diffuser plate, in some of its embodiments of the disclosure.

FIG. 6 is a perspective view of an arrangement of the diffuser plates exhibiting the effect of the compressive force controllable by the size of the bubbles.

FIG. 7 is a graph of representation of the operation of the bubbler in terms of the size of the bubbles as a function of the compressor.

For a better understanding of the disclosure, the detailed description will be given of some of the embodiments thereof, shown in the drawings which for illustrative purposes but not limitative are attached to the present description. It should be understood that the spacing of the filter plates in the drawings may be exaggerated to improve illustration and understanding.

### DETAILED DESCRIPTION

In view of the background, the inventor has discovered a need to have a poly-ionic molecular diffuser and filtering device which may solve of many drawbacks and deficiencies of the prior art. The present disclosure may offer important advantages in terms of structure, composition, assembly and functionality.

One object of the present disclosure to provide a poly-ionic molecular diffuser device which functions as a diffuser when used from the inside out, and as a filter when used from the outside inward, which may provide excellent filtration in macro, micro and nano ranges for a variety of fluids and gases.

Another object of the disclosure is to provide said poly-ionic and filter molecular diffuser device, which further uses filtration elements which are inexpensive, but with advantages that allow a periodic back-up to remove solids that release material from the accesses of the diffuser.

Another object of the disclosure is to provide said poly-ionic molecular diffuser and filtration device, which further employs a filter system where the filter axes are perpendicular to the collection stream.

Another object of the disclosure is to provide such a poly-ionic and filtering molecular diffuser device, which further provides a way of adjusting the filter to separate the different solids measurements, depending on the setting used.

Another object of the disclosure is to provide said poly-ionic and filtering molecular diffuser device, which can also be adapted to operate as a gas diffuser which will deposit gas in a liquid in a controllable manner. Additional qualities and objectives which will become apparent upon reviewing the present specification and drawings.

Details of the poly-ionic molecular diffuser are shown clearly in the following description and in the accompanying illustrative drawings, the same reference signs serving to indicate the same parts.

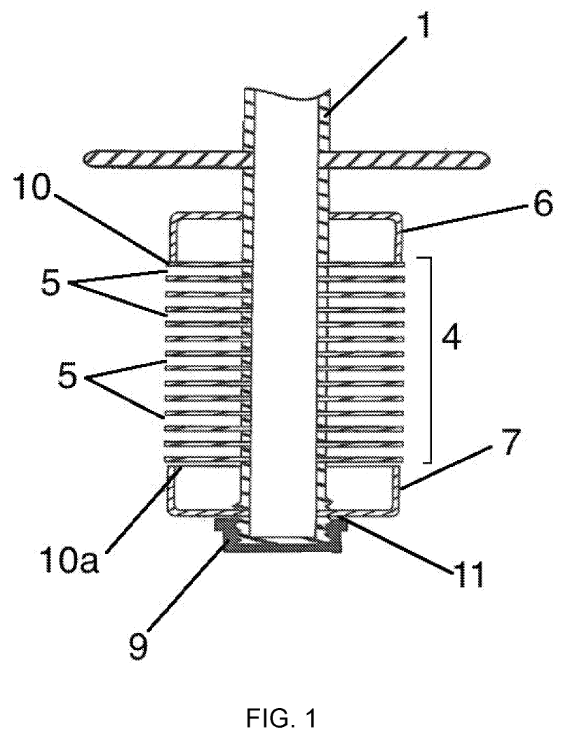

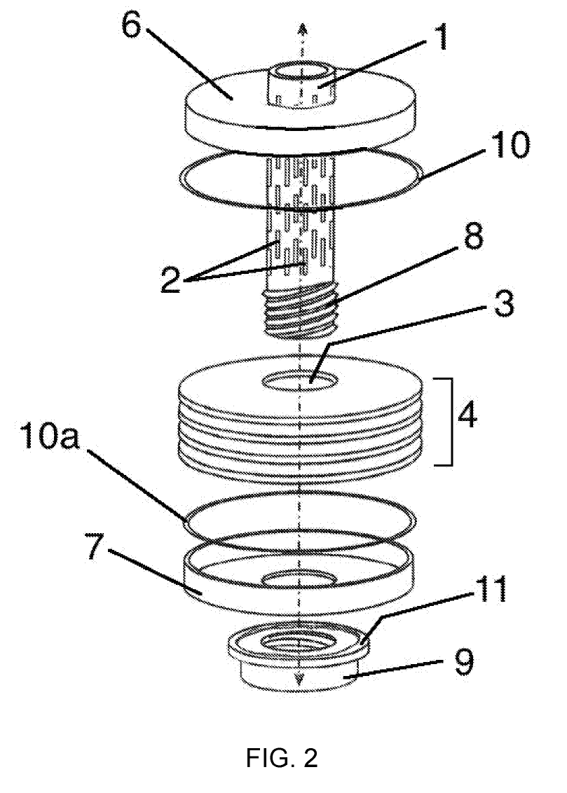

Referring to FIG. 1 and FIG. 2, the poly-ionic and filtration molecular diffuser device includes a central diffuser-collector tube 1 having or otherwise defining a plurality of perforations or slots 2 in its wall to allow the passage of gas. The central diffuser-collector tube 1 may be inserted through the central holes 3 of a plurality of diffuser plates 4 (arranged in a vertical arrangement), which may define a plurality of slots 5 between the separations generated therebetween. The diffuser plates 4 may be contained between a top compression cap 6 and a lower compression cap 7, through which the central diffuser tube 1 is also inserted. The central diffuser tube 1 includes a threaded lower end 8, in which a final lower lid 9 is threaded.

Seal elements 10, 10a are arranged between said upper compression cap 7, the lower compression cap 6 and the arrangement of the plurality of diffuser plates 4. Another seal element 11 is disposed between said end lower cap 9 and said lower compression cap 7.

A variety of materials may be used for the plurality of diffuser plates 4. However, it has been shown that the precision (optical) of the elements (high precision) is favorable.

Said upper compression cap 6 and a lower compression cap 7 are similar to the configuration of the diffuser plates 4. However, they may vary in size either slightly larger or smaller in diameter.

It is shown in the figures that said upper compression cap 6 and a lower compression cap 7 have a concave bell which causes the upper edge thereof to be the point of contact with said diffuser plates 4. This design has proven to be particularly successful because it creates an outer dividing diffusion layer, with a central core causing a less restrictive flow.

The upper compression cap 6 and the lower compression cap 7 are pressed against the diffuser plates 4 and the lower end cap 9, which secures the far end of the central diffuser duct 1. It should be understood that in the arrangement of the elements of the assembly of said diffuser, the final lower lid (lower end cap 9) may be tightened or loosened, this will tighten or keep the diffuser plates 4 loose.

By adding compression to the diffuser plates 4, the height of the stack forming them will be reduced and the spaces between each diffuser plate 4 will be reduced. Likewise, if the compression is reduced by loosening said end lower cover 9, the spaces between said diffuser plates 4 will increase due to the space between each of them.

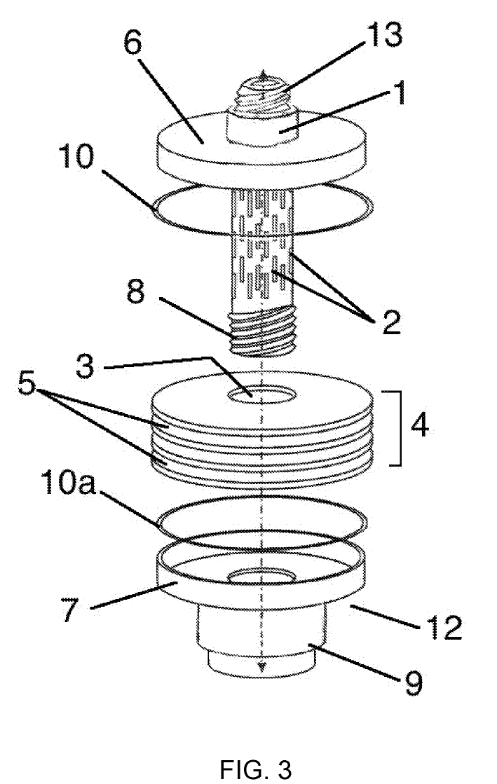

FIG. 3 shows an embodiment in which said lower end cap 9 is integrated with the lower compression cap 7, and forms a unitary body 12. It is also shown that the upper end of said central diffuser tube 1 may include a threaded upper end 13 adapted to engage a gas supply duct (not shown). The remainder of components are illustrated and identified by the same reference numerals as above, to denote the above-described parts in FIG. 1 and FIG. 2.

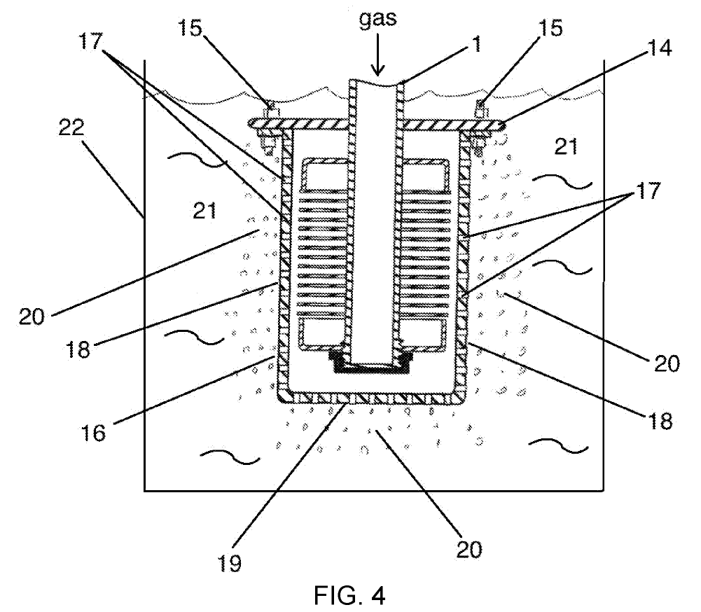

Referring to FIG. 4, the disclosure relates to a central diffuser tube 1 which includes a base plate 14 (for safety and stability) fixed to the upper end thereof. The base plate 14 is adapted to fasten with a fixing means 15 to a cylindrical housing 16, said cylindrical housing 16 having a plurality of apertures 17 in its perimeter wall 18 and bottom wall 19 that are configured to allow the exit of gas bubbles 20, which are injected through the upper end of said central diffuser tube 1.

Here, the diffuser is shown immersed in liquid 21 inside a liquid reservoir 22 and generates the bubbles 20 while the gas supply is operating at the upper end of said central diffuser tube 1

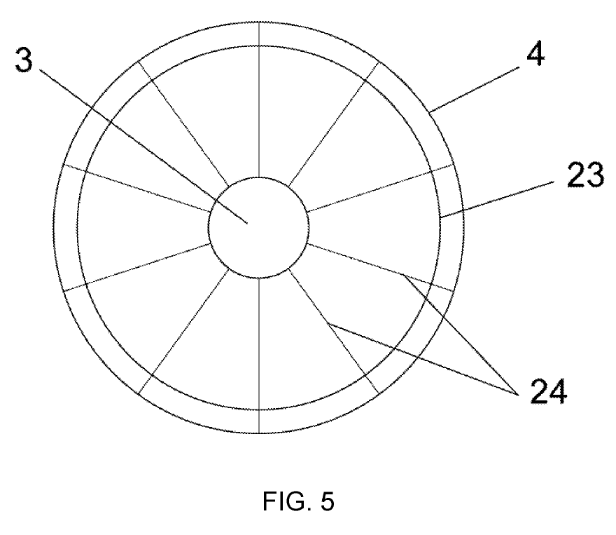

Referring now to FIG. 5, said plurality of diffuser plates 4 may include at least one circumferential groove 23 at the outer edge preferably, and a plurality of radial grooves 24 on one or both of the top and bottom faces, interconnected with the central orifice 3 (through which said central diffuser tube 1 passes) to improve the radial distribution of the gas flow.

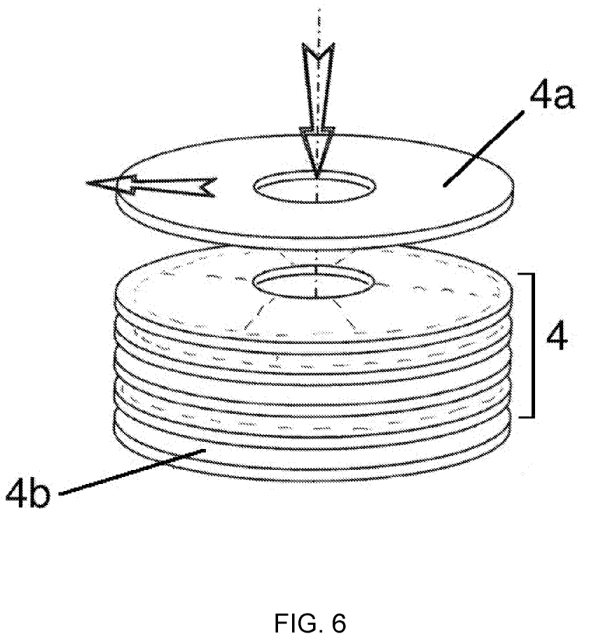

FIG. 6 illustrates a group of diffuser plates 4 with the configuration as described above. According to one embodiment, the group of diffuser plates 4 may include an upper diffuser plate 4a that does not have the above mentioned grooves (or at least its upper face being grooveless). Similarly, the group of diffuser plates 4 may include a lower diffuser plate 4b, where its lower face might not have the grooves. This is because a seal can be formed between said diffuser plates 4a, 4b and the seal elements 10, 10a (see FIG. 2 and FIG. 3).

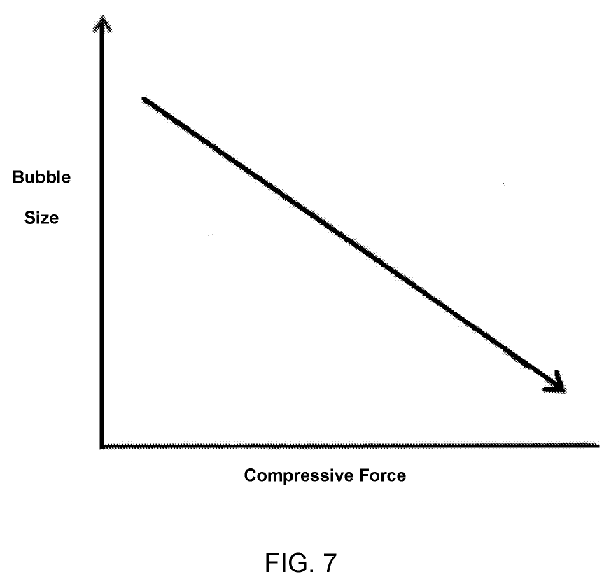

FIG. 7 shows a graph showing the inversely proportional relationship between the size of the bubble with respect to the compressive force of the plurality of diffuser plates 4.

One benefit of the disclosed devices is that they can be effectively used as a gas diffuser in liquids. The parallel plates serve very well to convert incoming gas into bubbles of manageable size, to aerate the liquid. The apparatus may be suitable for filtering air exiting the diffuser since the gas will deposit any matter or fumes (such as cigarettes) into the liquid. This poly-ionic aeration system can be used in fish ponds, water treatment plants, etc., depending on the air quality used.

The disclosure has been sufficiently described so that a person of ordinary skill in the art can reproduce and obtain the results mentioned in the present disclosure. However, any skilled person in the field of the art of the present disclosure may be able to make modifications not described in the present application, however, if for the application of these modifications in a particular structure or in the manufacturing process thereof, the subject claimed in the following claims is required, said structures should be understood within the scope of the disclosure.

1. A device for filtration and diffusion of gases and liquids, the device comprising:
a central diffuser-collector tube (1) having a vertical center axis and a tube wall, said central diffuser-collector tube including a plurality of perforations through the tube wall, said plurality of perforations configured to allow the passage of the gases and liquids;
a plurality of diffuser-separating plates (4) arranged in a vertical array, relative to the vertical center axis, with spacings in between each of the plurality of diffuser-separating plates, said vertical array defining a plurality of paths where the gases and liquids can be diffused or filtered;
an upper compression cap (6) affixed to the central diffuser tube, and compressibly coupled against an upper end of the plurality of diffuser-separating plates, relative to the vertical center axis;
a lower compression cap (9) compressibly coupled against a lower end of the plurality of diffuser-separating plates, relative to the vertical center axis; and
a lower end cap (7) affixed to the central diffuser tube and configured as a ground to the lower compression cap and against compressive forces from the plurality of diffuser-separating plates; and
wherein the central diffuser tube passes through the upper compression cap, then the plurality of diffuser-separating plates, and then the lower compression cap, relative to the vertical center axis, and such that the plurality of diffuser-separating plates and at least one of the upper compression cap and the lower compression cap are adjustably coupled to the central diffuser tube relative to the vertical center axis.

2. A poly-ionic and molecular filtration diffuser device comprising a central diffuser-collector tube defining a plurality of perforations in its wall to allow the passage of gas-liquids and which is inserted through the central holes of a plurality of diffuser-separating plates arranged in a vertical array, which define a plurality of slots by the spacings generated in between, where the gas is spread or penetrates the liquid to be filtered; said diffuser-separator plates are contained between a top compression cap and a lower compression cap through which said central diffuser-collector tube is also inserted; the diffuser-collector tube comprises a threaded lower end wherein a final lower lid is threaded; seal elements are disposed between said upper and lower compression caps and the arrangement of the plurality of diffuser plates.

3. The poly-ionic and molecular filtration diffuser device according to claim 2, further comprising a seal element disposed between said final lower lid and said lower compression cap.

4. The poly-ionic and molecular filtration diffuser device according to claim 2, characterized in that a seal element is integrated in said final lower lid.

5. The poly-ionic and molecular filtration diffuser device according to claim 2, characterized in that said lower end cap is integrated with said lower compression cap forming a unitary body.

6. The poly-ionic and molecular filtration diffuser device according to claim 2, characterized in that said central diffuser-collector tube comprises a threaded upper end adapted to couple a filtered gas supply or collection pipeline.

7. The poly-ionic and molecular filtration diffuser device according to the preceding claims, characterized in that said central diffuser-collector tube comprises fixedly next to its upper end a base plate adapted to fix with a fastening means a housing that protects internally the assembly of said central diffuser-collector tube with said diffuser-separating plates and the upper and lower compression caps secured with said final lower lid, and wherein said housing has a plurality of apertures in its perimetral and bottom wall allowing the gas bubble outlet being injected through the upper end of said central diffuser-collector tube or the liquid inlet being injected through the outer perimeter of the housing.

8. The poly-ionic and molecular filtration diffuser device according to claim 2, characterized in that said plurality of diffuser-separating plates comprise at least one circumferential groove at the outer or inner edge, at one or both of the top and bottom faces.

9. The poly-ionic and molecular filtration diffuser device according to claim 2, characterized in that said plurality of diffuser-separating plates comprise a plurality of circumscribed circumferential grooves, made in one or both upper and lower faces to improve the distribution of the gas flow or collected liquid.

10. The poly-ionic and molecular filtration diffuser device according to claims 2, 8, and 9, characterized in that said plurality of diffuser-separating plates comprise a plurality of radial grooves on one or both upper and lower surfaces interconnected with the central orifice by where said central diffuser-collector tube passes, to improve the radial distribution of the filtered gas or liquid stream.
